(19) United States
(12) Patent Application Publication
(10) Pub. No.: US 2025/0054037 A1
(43) Pub. Date: Feb. 13, 2025

(54) System and Methods for a Business Acquisition Marketplace

(71) Applicant: Private Market Labs Inc., Austin, TX (US)

(72) Inventors: Joshua Levine, Austin, TX (US); Titus Capilnean, Austin, TX (US)

(21) Appl. No.: 18/673,705

(22) Filed: May 24, 2024

Related U.S. Application Data
(60) Provisional application No. 63/469,232, filed on May 26, 2023.

(51) Int. Cl. G06Q 30/0601

(52) U.S. Cl. CPC G06Q 30/0613

(57) ABSTRACT

A system may include an acquisition system, a matching system and a feedback system. The acquisition system may access information from data sources on a network and may output data objects to a database. The matching system may utilize a machine learning algorithm and may generate a match report based on matching at least one data object. The feedback system may modify the acquisition system based on feedback from unstructured text and from user input.

### FIELD OF THE INVENTION

The present disclosure relates to a system and methods for a business acquisition marketplace, more specifically a system and methods to improve the speed, accuracy and efficiency of a business acquisition marketplace.

### PRIORITY INFORMATION

The present application claims the benefit of U.S. Provisional Application 63/469,232, filed May 26, 2023, the entire contents of which are incorporated herein.

### BACKGROUND OF THE INVENTION

The small business mergers and acquisitions market is vibrant, with many buyers, sellers, and service providers. The market is both massive and underserved. Small business owners may seek to sell their businesses for a variety of reasons. Owners may retire, may seek to monetize a successful small business, may encounter challenging personal situations such as divorce or poor health, may want to pursue new opportunities, or may pursue a sale for another reason. Buyers may seek to be operators of a small business, but may not want to pursue the long and risky process of building a small business from scratch. Buyers of small businesses may be individual entrepreneurs, groups, professional investors such as private equity funds and family offices, employee ownership groups or other types of buyers. Others may want access to the small business mergers and acquisitions market, including investors, lenders, and other service providers.

Buyers may acquire businesses through a variety of methods, including asset sales, stock sales, employee buyouts, and other methods. Buyers may purchase an entire business, or may purchase a portion of a business. These transactions may be financed through a variety of funding sources. These funding sources may include, but are not limited to, investor capital, individual capital, government-backed debt (such as a Small Business Administration loan), seller financing, or other debt or financing methods. Investors or lenders may provide funds for an entire acquisition, or may provide a portion of the funds.

Successfully navigating a small business acquisition requires significant coordination between the buyer, seller, and numerous other service providers facilitating the deal. These other service providers may include, but are not limited to, lawyers, sell-side representatives (such as business brokers or investment bankers), lenders, investors, quantitative analysts, consultants, HR experts and other professionals.

Existing systems and methods for matching buyers, sellers and service providers are manual, cumbersome and inefficient. A buyer may engage in manual or inefficient tasks including: reading through long lists of businesses which are classified by a small number of fixed data fields, spending thousands of dollars on large datasets which must be analyzed manually or analyzed through the hiring of additional technologists or laborers and spending hundreds of hours building relationships with potential sellers and seller representatives in hopes of identifying a future deal. Sellers may be forced to analyze large lists of potential buyers, lenders or investors looking for a buyer or a funding partner.

Because existing marketplaces are ineffective, most dealmaking takes place away from open markets, with small businesses being passed between friends or in closed networks, suppressing sellers' upside and reducing the number of buyers, sellers and service providers with access to these opportunities. A prospective buyer without connections has access to only a small segment of potential deals. A prospective buyer may expend time, energy and money pursuing a possible purchase, only to abandon the effort upon discovering the business is not a good match for the buyer's preferences. These aborted transactions also impose costs, delays and inconvenience for sellers and service providers. A prospective seller may fail to attract a buyer for their business due to a mismatch between their business and the preferences of the buyers actively searching for acquisitions on the marketplace where the seller's business is listed.

Additionally, there are limited existing systems and methods for matching business buyers, sellers and service providers unique to the specific business deal, and also existing systems and methods are not capable of managing the full deal terms within the context of a deal negotiation. As one of various examples, a buyer acquiring a landscaping business may need to consult with an environmental attorney with expertise in local restrictions on water consumption and chemical usage, hire an accountant to help review the business' chart of accounts, and hire a deal attorney to help draft deal documents. The buyer in this transaction would have to manage each of these processes separately, which is very inefficient. A different type of transaction may require a very different set of service providers. As one of various examples, a buyer acquiring an ice cream shop may need to consult with an employment attorney with expertise in local wage rules and labor force rights and may need assistance from a human resources expert to manage hiring and staff scheduling.

The management of the full acquisition process requires maintenance of legal documents, payment information, organization of spreadsheets, communication threads, and various information requests. All this complexity has a cooling effect on the overall market and can lead to a decrease in overall dealflow.

There is a need for a system and method to systematically collect and connect disparate, unstructured and unrelated information across different industries and generate matches between buyers, sellers and service providers.

### SUMMARY OF THE INVENTION

The disclosed invention enables a system for matching buyers, sellers and service providers, the system comprising a processor coupled to a network, the processor coupled to a non-transitory memory, the processor to execute instructions stored in the non-transitory memory. The non-transitory memory comprises an acquisition system. The acquisition system comprises instructions stored in the non-transitory memory, the instructions, when executed by the processor, cause the processor to access information from data sources on the network, to perform a data transformation on the accessed information, to output one or more data objects to a database, the data objects based on the data transformation, the data objects comprising data transformation data objects based on characteristics of businesses and characteristics of service providers and preference data objects based on at least one of buyer, seller and service provider preferences. The non-transitory memory comprises a matching system including instructions stored in the non-transitory memory, the instructions, when executed by the processor, cause the processor to access the one or more data objects stored in the database, to execute a machine learning matching algorithm based on the data objects accessed from the database, the machine learning matching algorithm to create an output based on matching data transformation objects and preference data objects, and to generate a match report based on the output of the machine learning matching algorithm, the match report comprising matches of at least one user with at least one other user. The non-transitory memory further comprises a feedback system including instructions stored in the non-transitory memory, the instructions, when executed by the processor, cause the processor to extract a set of feedback characteristics from an unstructured text input and from user actions, and to modify at least one of the acquisition system, the matching system and the machine learning matching algorithm based on the feedback characteristics.

A method of matching prospective buyers, sellers and service providers, the method comprising the steps of: accessing information from data sources on a network, extracting data objects from the accessed information and storing the data objects in a database, the data objects comprising data transformation data objects based on characteristics of businesses and characteristics of service providers and preference data objects based on at least one of buyer, seller and service provider preferences, accessing the data objects from the database and executing a machine learning matching algorithm based on the data objects, and generating a match report based on the output of the machine learning matching algorithm.

### BRIEF DESCRIPTION OF THE DRAWINGS

FIG. 1 illustrates one of various examples of a system for a business acquisition marketplace.

FIG. 2 illustrates one of various examples of a method of matching buyers, sellers and service providers.

### DETAILED DESCRIPTION

The following description includes specific details to provide an understanding of a system and methods for a business acquisition marketplace. Embodiments of the business acquisition marketplace described in the following description may be incorporated into other devices not disclosed in the following description. Structures and elements shown in the drawings are exemplary embodiments of the business acquisition marketplace and are not to be used to limit broader teachings of the business acquisition marketplace.

It is understood through the text of this disclosure that where elements are described as separate functional units, those skilled in the art will recognize that various elements or portions thereof may be integrated together. Where elements are described in the following description as integrated together into a combined element, those skilled in the art will similarly recognize that individual elements of the combination may be utilized as separate elements.

This specification includes references to “an embodiment of the business acquisition marketplace” or “one embodiment of the business acquisition marketplace”. This language is intended to refer to the particular elements and structures of the embodiment being discussed in that portion of the specification. Where references are made to “an embodiment of the business acquisition marketplace” or “one embodiment of the business acquisition marketplace” in other portions of the specification, those similarly refer to those particular elements and structures of the embodiment being discussed in that portion of the specification. Embodiments discussed in different portions of the specification may or may not refer to the same embodiment of the business acquisition marketplace.

The use of specific terminology in the specification is used for best describing the business acquisition marketplace and shall not be construed as limiting. The terms “include”, “including”, “comprise” and “comprising” shall be understood to be open terminology and not limiting the listed items.

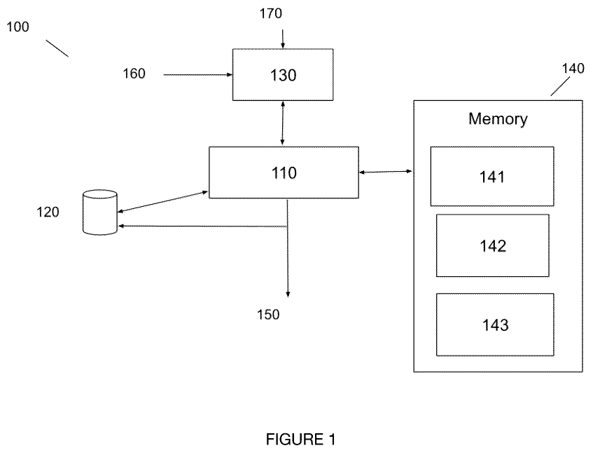

FIG. 1 illustrates one of various examples of a system 100 for matching prospective buyers, sellers and service providers. Buyers, sellers and service providers may also be referred to as users of system 100. System 100 may match at least one user with at least one other user. System 100 may match buyers with sellers, may match buyers with service providers, may match sellers with service providers, or may match other combinations of users not specified explicitly. System 100 may include a network-connected processor 110. Processor 110 may be a Lambda processor or other serverless computing service. Processor 110 may be a local Jupyter notebook executing instructions on a local computer. Processor 110 may be a local processor on a computing system.

Processor 110 may be coupled to database 120. Processor 110 may write data to database 120 and processor 110 may read data from database 120.

Database 120 may be a Simple Storage Service (S3) database or another form of cloud-based object storage. Database 120 may be a Relational Database Service (RDS). Database 120 may be accessed via a web interface or via an Application Programming Interface (API).

Processor 110 may be coupled to network 130. Processor 110 may be coupled to network 130 via a wireless connection or processor 110 may be coupled to network 130 via a wired connection. Processor 110 may access data over network 130.

Processor 110 may be coupled to non-transitory memory 140. Non-transitory memory 140 may include one or more systems, these systems comprising instructions stored in non-transitory memory 140. Processor 110 may execute instructions stored in non-transitory memory 140. In one of various examples, non-transitory memory 140 may include acquisition system 141, matching system 142 and feedback system 143.

Unstructured text input 160 may be accessed by processor 110 over network 130. In operation, processor 110 may access data from database 120, network 130, and memory 140, and may generate match report 150.

Data accessed by processor 110 may include information and characteristics related to business acquisitions. Data accessed by processor 110 may include names of businesses and business-specific information and characteristics, the business-specific information and characteristics including but not limited to geographic information, product information, personnel information, financial information or other information related to a specific business. Data accessed by processor 110 may include information and characteristics related to the sale of a business, including but not limited to a duration of time the business has been listed for sale, a reason for the sale, status of the listing (listed or unlisted), real estate information included owned and leased assets, business model and service type information. Data accessed by processor 110 may include information about investors, including but not limited to investment targets and theses, funds available to invest, investment strategy, geographic information or other information. Data accessed by processor 110 may include information and characteristics related to service providers, including but not limited to loan providers, legal service providers, investment bankers, management consultants, and deal brokers. Information related to service providers may include recent transactions, areas of expertise, rates, geographic information and other information. Data accessed by processor 110 may include information and characteristics related to business brokers and sell side advisors, including but not limited to types of businesses served, industries served, biographical and descriptive information, typical deal size, typical deal financial information, geographies served and other information.

Network 130 may be a public or a private network. Processor 110 may access public information on the Internet or another publicly available network 130. Processor 110 may access private information in a private network 130 provided by a third party.

Processor 110 may access structured information over network 130 in the form of a table, a list, an array, an XML database, a key-value database, an object-oriented database, or another format not specifically mentioned. Processor 110 may access unstructured information over network 130 in the form of text, graphics, direct user input, or images. Processor 110 may access semi-structured information over network 130, which may be a combination of structured and unstructured information.

Processor 110 may access information in many different formats over network 130, including but not limited to text, HTML, Javascript, PDF or other formats not specifically mentioned.

Processor 110 may access instructions stored in non-transitory memory 140. Processor 110 may access instructions stored in acquisition system 141. Instructions stored in acquisition system 141 may instruct processor 110 to access structured information over network 130 and may process the accessed structured information and perform a data transformation on the accessed structured information. Instructions stored in acquisition system 141 may include scripts in Python, SQL, R, or other languages not mentioned here. The data transformation may include parsing and classifying of structured information into one or more categories, filtering of structured information to de-emphasize some information and emphasize other information, and aggregating information based on common attributes. The output of the data transformation of structured information may be data transformation data objects, the data transformation data objects stored in database 120 by processor 110.

Instructions stored in acquisition system 141 may instruct processor 110 to access unstructured information over network 130 and to process the accessed unstructured information and perform a data transformation on the accessed unstructured information. The data transformation may include parsing and classifying of unstructured information into one or more categories, classification of unstructured information to one or more data objects, extraction of preferences and characteristics from unstructured information, filtering of unstructured information to de-emphasize some information and emphasize other information, and aggregating information based on common attributes. The output of the data transformation of unstructured information may be data transformation data objects, the data transformation data objects stored in database 120 by processor 110.

Processor 110 may receive input from unstructured text input 160 over network 130. Unstructured text input 160 may represent preferences of a user related to a business acquisition. Preferences may include business type and location, financial performance targets, business size, or other preferences of a prospective buyer. Preferences may include business type and location, financial performance targets, business size, or other preferences of a prospective investor or lender. Preferences may include business type and location, financial performance targets, business size, or other preferences of a prospective service provider. Preferences may include type of investor of buyer, deal terms, previous transactions, or other preferences of a prospective seller. Processor 110 may process the unstructured text input and perform a data transformation on unstructured text input 160. The data transformation may include parsing and classification of unstructured text input 160 into one or more categories, extraction of preferences and characteristics from unstructured text input, filtering of unstructured text input 160 to de-emphasize some information and emphasize other information, and aggregating information based on common attributes. The output of the data transformation on unstructured text input 160 may be preference data objects stored in database 120 by processor 110, the preference data objects based on a set of preferences.

Processor 110 may access instructions stored in matching system 142. Instructions stored in matching system 142 may instruct processor 110 to access data transformation data objects stored in database 120. The data transformation data objects may be data objects stored in database 120. Instructions stored in matching system 142 may instruct processor 110 to access preference data objects accessed from database 120. Instructions stored in matching system 142 may include scripts in Python, SQL, R, or other languages not mentioned here. Processor 110 may process data transformation data objects and preference data objects stored in database 120 according to a machine learning matching algorithm, the machine learning matching algorithm comprising instructions in matching system 142. The machine learning matching algorithm may be a large language model trained on an industry-specific data model. Matching system 142 may apply the machine learning matching algorithm to generate an output based upon matching the preference data objects with data transformation data objects. The output of matching system 142 may be based on matching at least one user to at least one other user. Processor 110 may generate match report 150 based on the output of matching system 142. Match report 150 may include matches between users and other users and data objects, such as buyers, sellers, businesses for sale and service providers. Match report 150 may be written to database 120 and accessed by processor 110. Processor 110 may access match report 150 and transmit match report 150 over network 130. Match report 150 may include matches of businesses with users based on the preference data objects stored in database 120 and based on the output of the data transformation data objects stored in database 120. Match report 150 may include matches of businesses for sale with potential buyers. Match report 150 may include matches of investors with potential businesses in need of investment. Match report 150 may include matches of sellers with potential service providers to support a sale of a business. Match report 150 may include matches of buyers with potential service providers to support a purchase of a business. Match report 150 may include matches of service providers with businesses in need of services provided by the service provider. Match report 150 may include matches not explicitly mentioned in this disclosure.

Processor 110 may access instructions stored in feedback system 143. Instructions stored in feedback system 143 may instruct processor 110 to process feedback input 170. Instructions stored in feedback system 142 may include scripts in Python, SQL, R, or other languages not mentioned here. Feedback input 170 may be a qualitative rating based on the quality of the output of matching system 142 and the contents of match report 150. Feedback input 170 may be based on processing of unstructured text feedback. Feedback input 170 may be based on an analysis of user actions. Feedback system 143 may process feedback input 170 and generate feedback characteristics based on feedback input 170. Feedback system 143 may provide updates to instructions stored in matching system 142 or to instructions stored in acquisition system 141 based on the generated feedback characteristics. Updates to acquisition system 141 may modify the process of data transformation applied to accessed structured, unstructured and semi-structured data. Updates to matching system 142 may remove portions of matching system 142 which, based on feedback input 170, do not lead to useful outputs of matching system 142. Updates to matching system 142 may modify weights and biases in the machine learning matching algorithm. Updates to matching system 142 may modify connections between nodes of different layers of the machine learning matching algorithm. Updates to matching system 142 may improve the speed of system 100 and improve the accuracy of outputs of matching system 142 and the accuracy of match report 150.

Processor 110 may access instructions stored in acquisition system 141, matching system 142 and feedback system 143 in real-time, based on live unstructured text input 160. Processor 110 may access instructions stored in acquisition system 141, matching system 142 and feedback system 143 in an off-line mode, based on unstructured text input 160 provided via a file or database input accessed over network 130.

As one of various examples, processor 110 may access, over network 130, publicly available information on the Internet related to service businesses, though this example is not intended to be limiting. Instructions in acquisition system 141 may instruct processor 110 to access, over network 130, publicly available information on the Internet related to any type of business. Processor 110 may access structured tables or other structured information including business names, business locations, business size and business financial information. Processor 110 may access names of businesses and business-specific information, the business-specific information including but not limited to geographic information, product information, personnel information, financial information or other characteristics related to a specific business. Processor 110 may access other business-related information, including but not limited to a duration of time the business has been listed for sale, a reason for the sale, status of the listing (listed or unlisted), real estate information including owned and leased assets, business model and service type information. Processor 110 may access additional information on service-related businesses. Processor 110 may access unstructured text, table and image information based upon a web scraping operation. The publicly available information may be transformed by acquisition system 141 and written to database 120 as data transformation data objects.

Processor 110 may receive unstructured text input 160 from a user. Unstructured text input 160 may be transformed by acquisition system 141 and written to database 120 as preference data objects, the preference data objects representing preferences of a user related to a business acquisition. Preferences may include business type and location, financial performance targets, business size, or other preferences of a prospective buyer, seller or service provider. As one of various examples, unstructured text input 160 may be unstructured text to represent a prospective buyer's desire to acquire a business within 50 miles of a specific location, with fewer than 5 employees, and with at least $250,000 in annual revenue, though this example is not intended to be limiting. As one of various examples, unstructured text input 160 may be unstructured text to represent an investor's desire to invest in or purchase a business in a large city with more than 5 locations and up to 25 employees, though this is not intended to be limiting. As one of various examples, unstructured text input 160 may be unstructured text to represent a lender's desire to finance a business acquisition of more than $1,000,000, though this is not intended to be limiting. Matching system 142 may process the data transformation data objects and the preference data objects according to a machine learning matching algorithm. Matching system may output match report 150. Match report 150 may include a list of businesses and service providers matched to the user's specific unstructured text input 160 preferences.

The machine learning matching algorithm of matching system 142 and the feedback system 143 may operate a Reinforcement Learning from Human Feedback (RLHF) system. The machine learning algorithm of matching system 142 may be trained based on a model. Feedback system 143 may receive feedback from feedback input 170. Feedback input 170 may be provided via text input from a keyboard or touch screen, via response to text queries, or via analysis of user actions. Feedback system 143 may update the machine learning matching algorithm of matching system 142 based on feedback input 170. Updates to the machine learning matching algorithm of matching system 142 may improve the speed of system 100 and improve the accuracy of outputs of matching system 142.

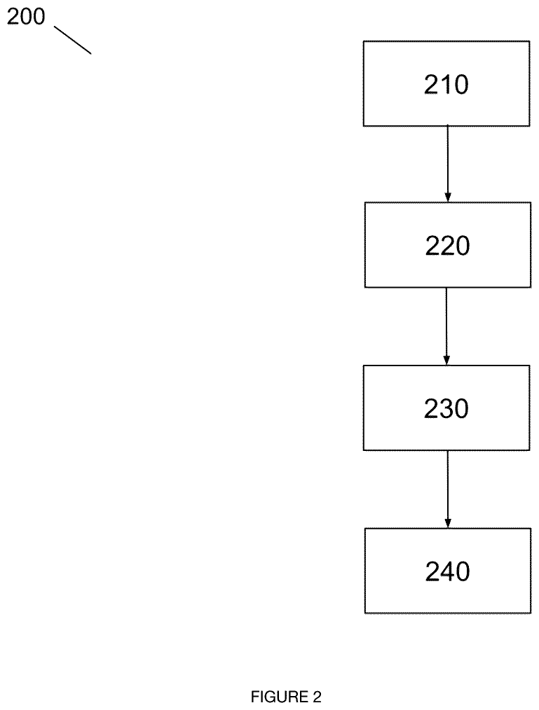

FIG. 2 illustrates one of various examples of a method 200 of matching buyers, sellers and service providers.

At operation 210, a processor may access information from data sources on a network. Information accessed may include structured and unstructured information. Information accessed may include information and characteristics related to business acquisitions. Information accessed may include names of businesses and business-specific information and characteristics, the business-specific information and characteristics including but not limited to geographic information, product information, personnel information, financial information or other information related to a specific business. Information accessed may include information and characteristics related to the sale of a business, including but not limited to a duration of time the business has been listed for sale, a reason for the sale, status of the listing (listed or unlisted), real estate information included owned and leased assets, business model and service type information. Information accessed may include information about investors, including but not limited to investment targets and theses, funds available to invest, investment strategy, geographic information or other information. Information accessed may include information and characteristics related to service providers, including but not limited to loan providers, legal service providers, investment bankers, management consultants, and deal brokers. Information related to service providers may include recent transactions, areas of expertise, rates, geographic information and other information. Information accessed may include information and characteristics related to business brokers and sell side advisors, including but not limited to types of businesses served, industries served, biographical and descriptive information, typical deal size, typical deal financial information, geographies served and other information.

At operation 220, a processor may extract data objects from the accessed information and store the data objects in a database. The data objects may include data transformation data objects based on characteristics of businesses and characteristics of service providers and preference data objects based on at least one of buyer, seller and service provider preferences.

At operation 230, a processor may access the data objects from the database and executing a machine learning matching algorithm based on the data objects.

At operation 240, the processor may generate a match report. The match report may include a list of businesses and service providers matched to the user's specific preferences. The match report may include matches of businesses with users based on the data objects stored in the database. The match report may include matches of businesses for sale with potential buyers. The match report may include matches of investors with potential businesses in need of investment. The match report may include matches of sellers with potential service providers to support a sale of a business. The match report may include matches of buyers with potential service providers to support a purchase of a business. The match report may include matches of service providers with businesses in need of services provided by the service provider.

1. A system for matching buyers, sellers and service providers, the system comprising:
a processor coupled to a network, the processor coupled to a non-transitory memory, the processor to execute instructions stored in the non-transitory memory, the non-transitory memory comprising:
an acquisition system comprising:
instructions stored in the non-transitory memory, the instructions, when executed by the processor, cause the processor to:
access information from data sources on the network;
perform a data transformation on the accessed information, output one or more data objects to a database, the data objects based on the data transformation, the data objects comprising data transformation data objects based on characteristics of businesses and characteristics of service providers and preference data objects based on at least one of buyer, seller and service provider preferences;
a matching system comprising:
instructions stored in the non-transitory memory, the instructions, when executed by the processor, cause the processor to:
access the one or more data objects stored in the database;
execute a machine learning matching algorithm based on the data objects accessed from the database, the machine learning matching algorithm to create an output based on matching data transformation objects and preference data objects;
generate a match report based on the output of the machine learning matching algorithm, the match report comprising matches of at least one user with at least one other user,
a feedback system comprising:
instructions stored in the non-transitory memory, the instructions, when executed by the processor, cause the processor to:
extract a set of feedback characteristics from an unstructured text input and from user actions;
modify at least one of the acquisition system, the matching system and the machine learning matching algorithm based on the feedback characteristics.

2. The system as claimed in claim 1, wherein the information accessed from data sources on the network comprises structured information, unstructured information and semi-structured information.

3. The system as claimed in claim 1, wherein the characteristics of businesses comprise geographic information, product information, personnel information, and financial information.

4. The system as claimed in claim 1, wherein the characteristics of service providers comprise recent transactions, areas of expertise, rates, and geographic information.

5. The system as claimed in claim 1, wherein the match report comprises an ordered list of businesses matched to at least one of buyer, seller and service provider preferences.

6. The system as claimed in claim 1, wherein the match report comprises matches between users and other users and data objects, the data objects to represent buyers, sellers, businesses for sale and service providers.

7. A method of matching buyers, sellers and service providers, the method comprising:
accessing information from data sources on a network;
extracting data objects from the accessed information and storing the data objects in a database, the data objects comprising data transformation data objects based on characteristics of businesses and characteristics of service providers and preference data objects based on at least one buyer, seller and service provider preference;
accessing the data objects from the database and executing a machine learning matching algorithm based on the data objects, and
generating a match report based on the output of the machine learning matching algorithm.

8. The method as claimed in claim 7, wherein the information accessed from data sources on the network comprises structured information, unstructured information and semi-structured information.

9. The method as claimed in claim 7, wherein the characteristics of businesses comprise geographic information, product information, personnel information, and financial information.

10. The method as claimed in claim 7, wherein the characteristics of service providers comprise recent transactions, areas of expertise, rates, and geographic information.

11. The method as claimed in claim 7, wherein the match report comprises an ordered list of businesses matched to at least one of buyer, seller and service provider preferences.

12. The method as claimed in claim 7, wherein the match report comprises matches between users and other users and data objects, the data objects to represent buyers, sellers, businesses for sale and service providers.
